(19) United States
(12) Patent Application Publication
(10) Pub. No.: US 2017/0140457 A1
(43) Pub. Date: May 18, 2017

(54) DISPLAY CONTROL DEVICE, CONTROL METHOD, PROGRAM AND STORAGE MEDIUM

(71) Applicant: PIONEER CORPORATION, Tokyo (JP)

(72) Inventors: Fuminobu KAKU, Saitama (JP); Yuji YAMADA, Tokyo (JP); Kenji OMURA, Tokyo (JP)

(73) Assignee: Pioneer Corporation, Kanagawa (JP)

(21) Appl. No.: 15/127,598

(22) PCT Filed: Mar. 24, 2014
(86) PCT No.: PCT/JP2014/058082

§ 371 Date: Sep. 20, 2016

(51) Int. Cl. G06Q 30/06; G06F 3/0346; G06F 3/01; G06T 19/00

(52) U.S. Cl. CPC G06Q 30/0643; G06T 19/006; G06F 3/0346; G06F 3/017; G06F 3/011

(57) ABSTRACT

A server device, upon receiving a request signal S1 from a HMD 1 specifying present information, direction and the like, acquires a space ID regarding the position for displaying AR information, and acquires the AR information to be displayed with reference to an AR information table 241 from the space ID. Then, the server device 2 transmits a response signal S2 to the HMD 1 specifying the AR information to be displayed, the display position thereof and the like in order to let the HMD 1 display the AR information.

### TECHNICAL FIELD

The present invention relates to a technology for display information.

### BACKGROUND TECHNIQUE

Conventionally, there is known a technique for a head-mounted display and the like to suppress the deterioration of the visibility at the time of displaying guide information over the real scenery. For example, Patent Reference-1 discloses a portable terminal, which superimposes guide information on an image captured by a camera, capable of extracting an overlap prohibited object from the image in order not to display guide information which overlaps the overlap prohibited object, or in order to transparently display the guide information or change the display position thereof. Patent Reference-1 also discloses that the portable terminal does not display or transparently display the guide information without changing the display position thereof in such a case that the guide information with high priority of the display position overlaps the overlap prohibited object.

Patent Reference-1: Japanese Patent Application Laid-open under No. 2011-242934

### DISCLOSURE OF INVENTION

### Problem to be Solved by the Invention

In case of applying the technique described in Patent Reference-1 to a head-mounted display, when the user wearing the head-mounted display tries to see information on the present location, the guide information with high priority of the display position is not displayed or becomes low visibility due to the transparent display. This causes the user to feel inconvenient.

The above is an example of the problem to be solved by the present invention. An object of the present invention is to provide a display control device capable of preferably displaying guide information.

### Means for Solving the Problem

One invention is a display control device including: a guide information acquisition unit configured to acquire guide information on a guide to a target space and three dimensional coordinate information on a display position of the guide information in the target space; and a display control unit configured to let a display unit display the guide information to visually overlap the target space based on the guide information and the three dimensional coordinate information which are acquired by the guide information acquisition unit.

Another invention is a display control device including: a guide acquisition unit configured to acquire first shop guide information that is guide information on a first shop and second shop guide information that is guide information on a second shop; and a display control unit configured to let a display unit display the first shop guide information acquired by the guide acquisition unit to visually overlap a floor surface and a ceiling of a passage in front of the first shop and display the second shop guide information acquired by the guide acquisition unit to visually overlap a floor surface and a ceiling of the passage in front of the second shop.

Still another invention is a control method executed by a display control device, including: a guide information acquisition process to acquire guide information on a guide to a target space and three dimensional coordinate information on a display position of the guide information in the target space; and a display control process to let a display unit display the guide information to visually overlap the target space based on the guide information and the three dimensional coordinate information which are acquired by the guide information acquisition process.

Still another invention is a program executed by a computer, making the computer function as: a guide information acquisition unit configured to acquire guide information on a guide to a target space and three dimensional coordinate information on a display position of the guide information in the target space; and a display control unit configured to let a display unit display the guide information to visually overlap the target space based on the guide information and the three dimensional coordinate information which are acquired by the guide information acquisition unit.

### BRIEF DESCRIPTION OF THE DRAWINGS

FIG. 1 illustrates a schematic configuration of a display system.

FIG. 2 illustrates a functional configuration of a head-mounted display.

FIG. 3 is a block diagram of a server device.

FIG. 4 is an image illustrating indoor map information.

FIG. 5 indicates a data structure of an AR information table.

FIG. 6 is an example of a data structure of a shop information table.

FIG. 7 schematically illustrates the display position of the AR information of each shop at a floor passage.

FIG. 8 is a flowchart indicating a display process of the AR information.

FIGS. 9A to 9C indicate an overview of a display target space.

FIGS. 10A and 10B each illustrates a display example through a half mirror at the time of walking on a floor passage.

FIG. 11 is a display example through a half mirror in a case where a shop is observed from the front.

FIG. 12 is a display example through the half mirror at the time of walking on a floor passage.

### DETAILED DESCRIPTION OF THE PREFERRED EMBODIMENTS

According to a preferable embodiment of the present invention, there is provided a display control device including: a guide information acquisition unit configured to acquire guide information on a guide to a target space and three dimensional coordinate information on a display position of the guide information in the target space; and a display control unit configured to let a display unit display the guide information to visually overlap the target space based on the guide information and the three dimensional coordinate information which are acquired by the guide information acquisition unit.

The above display control device includes a guide information acquisition unit and a display control unit. The guide information acquisition unit is configured to acquire guide information on a guide to a target space and three dimensional coordinate information on a display position of the guide information in the target space. The display control unit is configured to let a display unit display the guide information to visually overlap the target space based on the guide information and the three dimensional coordinate information which are acquired by the guide information acquisition unit. According to this mode, the display control device can specify any position in the target space by the three dimensional coordinate information, and preferably display the guide information at the specified position.

In one mode of the display control device, the display control device further includes a position information acquisition unit configured to acquire information on a position of the display unit in the target space and an orientation in which the display unit is directed, wherein the display control unit is configured to determine, on a basis of the position and the orientation acquired by the position information acquisition unit, a display mode of the guide information acquired by the guide information acquisition unit and to let the display unit display the guide information. According to this mode, the display control device preferably determines the display mode of the guide information to be displayed based on the position of the display unit and the orientation thereof in order to display the guide information through the display unit.

In another mode of the display control device, the target space is a space including a ceiling and a passage, wherein the three dimensional coordinate information is coordinate information on the ceiling and the passage, and wherein the display control unit is configured to let the display unit display the guide information to visually overlap the ceiling or the passage based on the three dimensional coordinate information. According to this mode, the display control device can preferably display the guide information over the ceiling or the passage where the observer of the display unit can easily see.

In still another mode of the display control device, the display control unit is configured to switch the display position of the guide information or change a quantity of the guide information based on a traveling speed of the display unit. According to this mode, in such a case that the display unit moves together with the observer at a relatively high speed, the display control device can preferably suppress unnecessarily displaying the guide information which is hard for the observer to see.

In still another mode of the display control device, the display control unit is configured to change a content displayed as the guide information based on a timing to display the guide information through the display unit or a frequency to display the guide information through the display unit. According to this mode, it is possible to change the information which the observer visually recognizes as the guide information in accordance with the timing of the observer visually recognizing the display unit and the frequency thereof.

In still another mode of the display control device, the display control unit is configured to recognize, on a basis of position information on the display unit, a category of shops which an observer of the display unit frequently visits and let the display unit display information for navigating the observer to a shop falling under the category as the guide information. According to this mode, the display control device can preferably display the guide information in accordance with the observer's preference through the display unit.

In still another mode of the display control device, the guide information includes audio data, wherein the display control unit is configured to let an audio output unit output the audio data. According to this mode, the display control device can preferably guide the observer of the display unit by voice guidance.

In still another mode of the display control device, the display control device further includes a storage unit configured to associate and store guide information to be displayed with each of divided spaces into which the target space is divided, wherein the guide information acquisition unit is configured to acquire the guide information associated with at least one of the divided spaces included in a display range of the display unit and three dimensional position information of the at least one of the divided spaces. According to this mode, by identifying divided space(s) included in the display range of the display unit, the display control device can preferably determine the guide information to be displayed through the display unit.

In still another mode of the display control device, the display control device further includes a position information acquisition unit configured to acquire, from the display unit, information on a position of the display unit in the target space and an orientation where the display unit is directed, wherein the guide information acquisition unit is configured to recognize, on a basis of the position and the orientation, the at least one of the divided spaces included in the display range of the display unit thereby to acquire the guide information associated with the at least one of the divided spaces and the three dimensional position information thereof. According to this mode, the display control device can identify divided space(s) included in the display range of the display unit thereby to preferably determine the guide information to be displayed through the display unit.

According to another preferable embodiment of the present invention, there is provided a display control device including: a guide acquisition unit configured to acquire first shop guide information that is guide information on a first shop and second shop guide information that is guide information on a second shop; and a display control unit configured to let a display unit display the first shop guide information acquired by the guide acquisition unit to visually overlap a floor surface and a ceiling of a passage in front of the first shop and display the second shop guide information acquired by the guide acquisition unit to visually overlap a floor surface and a ceiling of the passage in front of the second shop. According to this mode, the display control device can display the guide information corresponding to the first shop and the second shop which are adjacent to each other over the floor surface and the ceiling thereof.

According to still another preferable embodiment of the present invention, there is provided a control method executed by a display control device, comprising: a guide information acquisition process to acquire guide information on a guide to a target space and three dimensional coordinate information on a display position of the guide information in the target space; and a display control process to let a display unit display the guide information to visually overlap the target space based on the guide information and the three dimensional coordinate information which are acquired by the guide information acquisition process. By executing the control method, the display control device can specify any position in the target space by the three dimensional coordinate information, and preferably display the guide information at the specified position.

According to still another preferable embodiment of the present invention, there is provided a program executed by a computer, making the computer function as: a guide information acquisition unit configured to acquire guide information on a guide to a target space and three dimensional coordinate information on a display position of the guide information in the target space; and a display control unit configured to let a display unit display the guide information to visually overlap the target space based on the guide information and the three dimensional coordinate information which are acquired by the guide information acquisition unit. By executing the program, the computer can specify any position in the target space by the three dimensional coordinate information, and preferably display the guide information at the specified position. Preferably, the program can be treated in a state that it is stored in a storage medium.

### Embodiment

Now, a preferred embodiment of the present invention will be described below with reference to the attached drawings.

[Configuration of Display System]

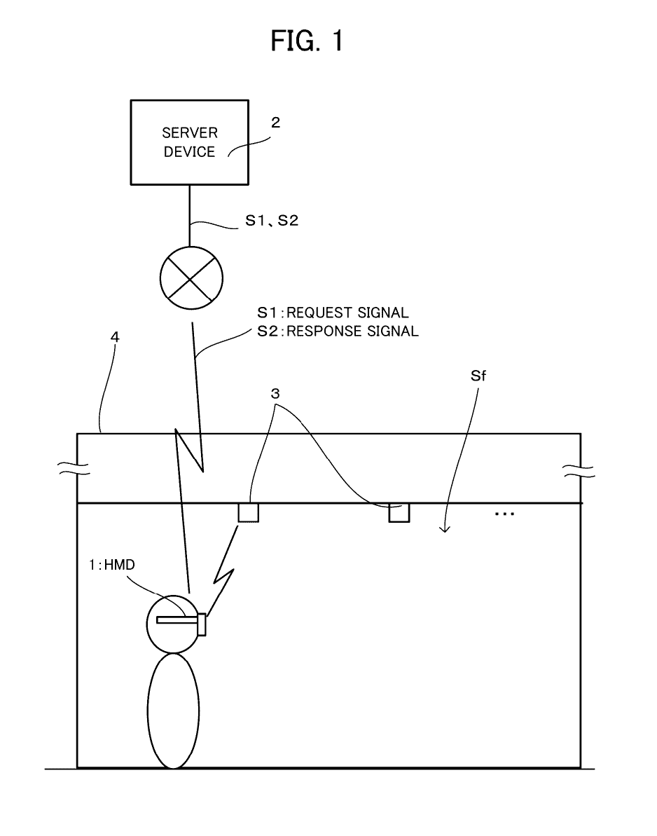

FIG. 1 illustrates a schematic configuration of a display system according to the embodiment. Hereinafter, a head-mounted display is conveniently referred to as “HMD”. As illustrated in FIG. 1, the display system mainly includes a HUD 1, a server device 2 and position information transmitters 3, wherein the HUD 1 is worn on a user who walks on a predetermined floor in a building 4 such as a shopping mall, and the server device 2 sends information to be displayed to the HMD 1, and the position information transmitters 3 are provided on each floor in the building 4. Then, through the HMD1, the display system displays advertisement image(s) corresponding to each shop over a ceiling or a floor surface in the building 4. Regarding the embodiment, the space of a floor on which the user of the HMD 1 walks in the building 4 is referred to as “floor space Sf”.

The HMD 1 is a see-through HMD configured to be a glass type, for example, and can be worn on the head of the user. For example, the HMD 1 displays an image visible to only one eye of the user or displays an image visible to both eyes of the user. According to the embodiment, the HMD 1 sends the server device 2 a request signal (referred to as “request signal S1”) of information (referred to as “AR information”) which the HMD 1 displays over the scenery. Then, the HMD1 receives a response signal (referred to as “response signal S2”) from the server device 2 in response to the request signal S1, and displays the AR information over the scenery such as a ceiling and/or a floor surface in the building 4.

The server device 2 communicates with the HMD 1 via a network, and on the basis of the request signal S1 sent from the HMD 1, the server device 2 recognizes a target space over which the HMD 1 displays an image in the floor space Sf. Then, the server device 2 sends the HMD 1 the response signal S2 specifying the AR information to be displayed over the target space, the display position of the AR information and the display size thereof.

Plural position information transmitters 3 are provided inside the floor space Sf and each sends information for identifying the present position (present position information) to the HMD 1 existing within the predetermined communication range thereof. Regarding the embodiment, it is assumed that the position information transmitter 3 is an IMES (Indoor MEssaging System). It is noted that the position information transmitter 3 may be any device to identify the position such as a sonic device which realizes indoor measurement, an access point for a wireless LAN and a visible light device.

[Configuration of HMD]

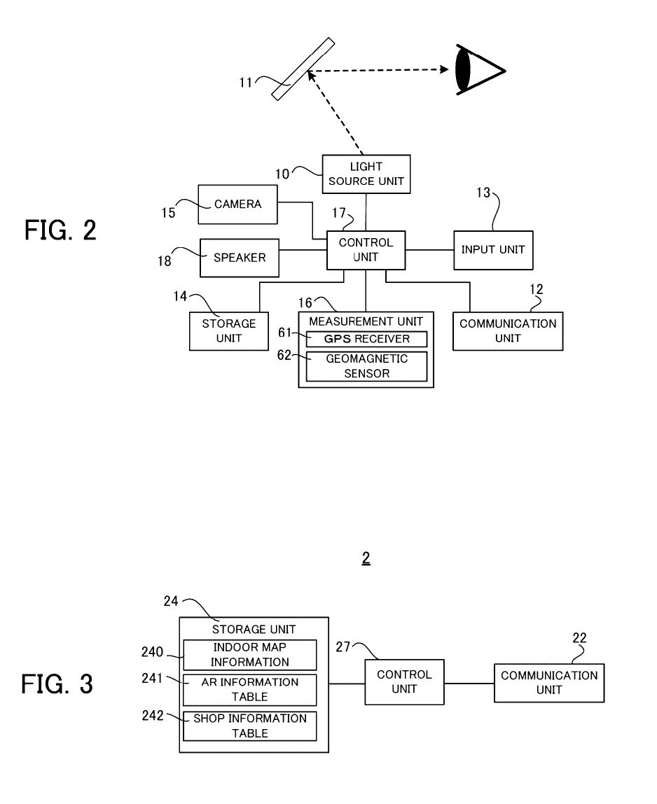

FIG. 2 illustrates a schematic configuration of the HMD 1. As illustrated in FIG. 2, the HMD 1 mainly includes a light source unit 10, a half mirror 11, a communication unit 12, an input unit 13, a storage unit 14, a camera 15, a measurement unit 16, a control unit 17 and a speaker 18. The HMD 1 is an example of “the display device” according to the present invention.

The light source unit 10 includes a light source of a laser or a LCD (Liquid Crystal Display) and emits light from the light source. The half mirror 11 reflects the light from the light source unit 10 towards the eyeballs of the user. Thereby, the virtual image corresponding to the image generated by the HMD 1 is visually recognized by the user. Though the transmittance and the reflectance of the half mirror 11 are substantially the same, any mirror (so-called beam splitter) whose transmittance and reflectance are different may be used instead of the half mirror 11.

Under the control of the control unit 17, the communication unit 12 performs a sending process of the request signal S1 to the server device 2 and a receiving process of the response signal S2 from the server device 2. The input unit 13 generates an input signal based on a user operation and sends it to the control unit 17. The input unit 13 may be a remote controller with buttons and arrow key(s) for accepting a user operation. The storage unit 14 stores programs executed by the control unit 17. The camera 15 generates an image captured towards the front of the HMD 1 and supplies the generated image to the control unit 17.

The measurement unit 16 is a sensor for detecting the state of the HMD 1 and includes a GPS receiver 61 for generating the position information indicating the present position and a geomagnetic sensor 62 for detecting the orientation. Here, at such an outdoor location that an electric wave for transmitting downlink data including position measurement data from GPS satellites can reach, the GPS receiver 61 generates the present position information of the HMD 1 by receiving the electric wave from the GPS satellites. In contrast, inside the building 4, the GPS receiver 61 receives the present position information indicating the three dimensional position in the floor space Sf from at least one of the position information transmitters 3 provided on each floor. For example, the present position information sent from the position information transmitter 3 includes information on the longitude, the latitude and the floor number. The speaker 18 outputs sound under the control of the control unit 17.

The control unit 17 includes processors such as a CPU and memories such as a RAM and a ROM which are not shown and controls the entire HMD 1. For example, the control unit 17 sends the server device 2 the request signal S1 specifying the present position information which the GPS receiver 61 receives from the position information transmitter 3 and the orientation which the geomagnetic sensor 62 measures. When receiving the response signal S2 from the server device 2 as a response of the request signal S1, the control unit 17 displays the AR information specified by the response signal S2 based on the information on the display position and the display size which are specified by the response signal S2. The control unit 17 also identifies the position of the ceiling and the floor surface from the image generated by the camera 15 based on a common image recognition technique, and adjusts the display position of the AR information so that the AR information overlaps the position of the target ceiling or the target floor surface.

It is noted that the control unit 17 may detect the direction of the line of sight of the user wearing the HMD 1 based on a common visual line recognition technique, and change the display position of the AR information on the half mirror 11 based on the detected direction of the line of sight. It is also noted that the HMD1 may further include an acceleration sensor and a gyro sensor as the measurement unit 16 and adjust the display position of the AR information by detecting the inclination with respect to the horizontal direction of the HMD 1. It is also noted the HMD 1 may recognize the position of the ceiling and the floor surface which are display targets by including an infrared radiation sensor and/or radar instead of the camera 15.

[Configuration of Server Device]

FIG. 3 is a schematic configuration of the server device 2. The server device 2 includes a communication unit 22, a storage unit 24 and a control unit 27. Under the control of the control unit 27, the communication unit 22 performs a receiving process of the request signal S1 and a sending process of the response signal S2.

The storage unit 24 stores programs executed by the control unit 27. The storage unit 24 also stores indoor map information 240, wherein with respect to each mesh space (referred to as “divided space”) into which the space inside the floor space Sf are divided in a reticular (grid) pattern are associated in the indoor map information 240 with the identification information (referred to as “space ID”) of the divided space and the three dimensional position thereof. The storage unit 24 also stores an AR information table 241 specifying each AR information to be displayed per space ID. Furthermore, the storage unit 24 stores a shop information table 242 indicating information on each shop existing inside the building 4. Each data structure of the indoor map information 240, the AR information table 241 and the shop information table 242 will be explained later.

The control unit 27 includes processors such as a CPU and memories such as a RAM and a ROM which are not shown and controls the entire server device 2. For example, when receiving the request signal S1, the control unit 27 identifies the space ID corresponding to a display target of the HMD 1 with reference to the indoor map information 240. Then, with reference to the AR information table 241, the control unit 27 regards the AR information corresponding to the identified space ID as the AR information to be displayed. Then, the control unit 27 sends the response signal S2 regarding the AR information to the HMD 1.

It is noted that the server device 2 is an example of “the display control device” according to the present invention. It is also noted that the control unit 27 is an example of “the guide information acquisition unit”, “the display control unit”, “the position information acquisition unit” and the computer which works based on the program according to the present invention.

Next, a detail description will be given of each kind of information stored on the storage unit 24.

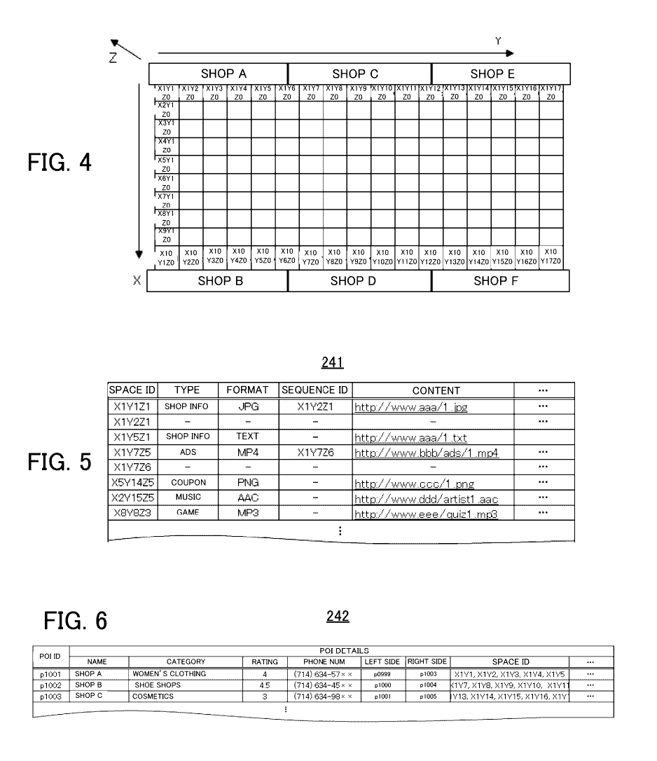

FIG. 4 is an image illustrating the indoor map information 240. As illustrated in FIG. 4, the floor space Sf is defined by the three dimensional space whose X-Y plane corresponds to the horizontal plane of the floor space Sf and whose Z axis corresponds to the height direction of the floor space Sf. It is noted that FIG. 4 illustrates the X-Y plane of the three dimensional space indicating the floor space Sf with respect to the Z coordinate “0”.

As indicated by FIG. 4, each space ID defined by X-Y-Z coordinates is assigned to each divided space into which the floor space Sf is divided in a reticular (grid) pattern. As the indoor map information 240, the storage unit 24 associates and stores each space ID defined by X-Y-Z coordinates per divided space with the three dimensional position information specified by the longitude and the latitude thereof. In the case of three dimensional coordinate space illustrated by FIG. 4, the position “Z=0” indicates the floor surface of the floor space Sf and the maximum position of Z indicates the ceiling of the floor space Sf. The space ID is an example of “the three dimensional coordinate information” according to the present invention.

FIG. 5 indicates a data structure of the AR information table 241. The AR information table 241 illustrated in FIG. 5 includes each item such as “SPACE ID” indicating the space ID, “TYPE” indicating the type of the AR information, “FORMAT” indicating the format of the AR information, “SEQUENCE ID” indicating the other space ID at the time when the AR information is displayed over multiple divided spaces, and “CONTENT” indicating the URL or the like indicating the storage place of the AR information. As illustrated in FIG. 5, examples of types of the AR information include not only shop information (SHOP INFO) and advertisements (ADS) but also a coupon (COUPON), music (Music) and a game (GAME).

In accordance with these types, examples of the format of the AR information includes the MP4 format that is a format of a moving image and the AAC format that is a format of audio data. Regarding the item “CONTENT” in FIG. 5, it is noted that the storage unit 24 may store path information indicating the storage place of the AR information instead of the URL information if the storage unit 24 itself stores the AR information. Regarding the item “CONTENT”, it is also noted that multiple pieces of AR information may be specified with respect to one space ID. For example, as described later, the server device 2 may store both storage places of audio data played at the time when the line of sight of the user of the HMD 1 is directed to the space and an image displayed at the time when the line of sight of the user of the HMD 1 is not directed to the space.

In this way, in the AR information table 241, each space ID is associated with information specifying AR information to be displayed. It is noted that an administrator of the server device 2 registers each data in the indoor map information 240 illustrated in FIG. 4 based on requests from each shop in the floor space Sf regarding each AR information and the display position thereof.

FIG. 6 is an example of a data structure of the shop information table 242. The shop information table 242 indicated by FIG. 6 includes each item such as “POI ID” indicating identification number of each shop, “NAME” indicating the name of each shop, “CATEGORY” indicating the category of each shop, “RATING” indicating an evaluation value by word of mouth, “PHONE NUM” indicating the telephone number, “LEFT SIDE” indicating the identification number of the shop existing on the left side, “RIGHT SIDE” indicating the identification number of the shop existing on the right side and “SPACE ID” indicating the space ID corresponding to the existing position of each shop.

[Display Position of AR Information]

A detail description will be given of the display position of the AR information to be registered in the AR information table 241 illustrated in FIG. 5.

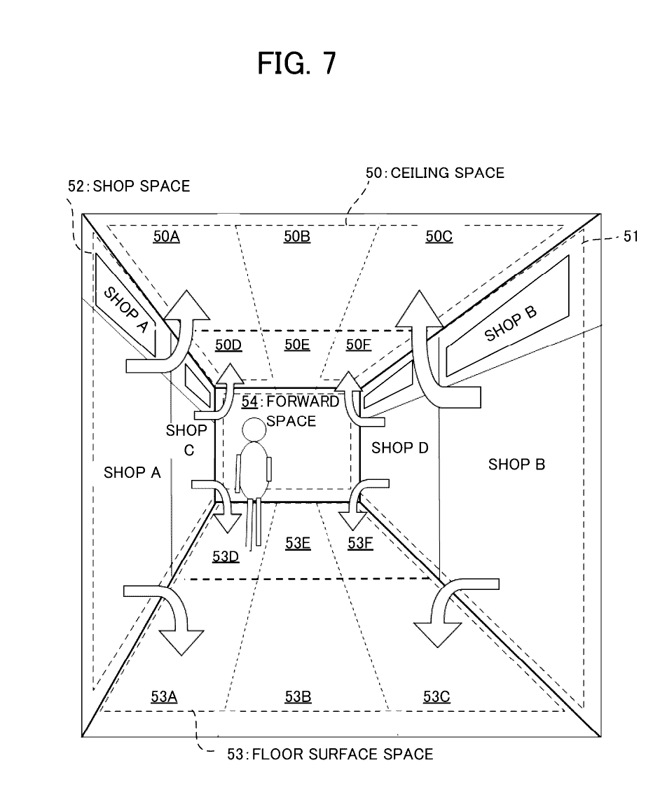

FIG. 7 schematically illustrates the display position of the AR information of each shop at the floor passage in the floor space Sf where the shops A to D exist. In the case of FIG. 7, the floor space Sf is divided into the ceiling space 50 that is a space of the ceiling part of the floor passage, the shop spaces 51 and 52 corresponding to the side parts of the floor passage where each shop exists, the floor surface space 53 that is a space of the floor surface part of the floor passage, and the forward space 54 that is a space except for the above-mentioned spaces.

Since the shop spaces 51 and 52 overlap the exterior, the interior and goods of each shop, the server device 2 does not associate any AR information with the space ID corresponding to the shop spaces 51 and 52 in the AR information table 241. Similarly, since the forward space 54 overlaps passengers in front, the server device 2 does not associate any AR information with the space ID corresponding to the forward space 54 in the AR information table 241 in principle.

The floor surface space 53 can be considered to be a space where the AR information can be displayed safely and effectively because the floor surface space 53 is near the field of view of the user and the user seems to move while maintaining a distance from a passenger in front. Thus, in the case of FIG. 7, the server device 2 determines the floor surface space 53A near the shop A as the display position of the AR information indicating advertisements and shop information of the shop A, determines the floor surface space 53C near the shop B as the display position of the AR information regarding the shop B, determines the floor surface space 53D near the shop C as the display position of the AR information regarding the shop C, and determines the floor surface space 53F near the shop D as the display position of the AR information regarding the shop D. Namely, in this case, the server device 2 associates each space ID corresponding to the floor surface spaces 53A, 53C, 53D and 53F with the AR information regarding each of the shops A to D and stores them on the AR information table 241.

The ceiling space 50 can be considered to be an appropriate space to display the AR information because it is unlikely to overlap people coming and going in front, though it is far from the field of the user's view and thereby not easy to see. Thus, in the case of FIG. 7, the server device 2 determines the ceiling space 50A near the shop A as the display position of the AR information regarding the shop A, determines the ceiling space 50C near the shop B as the display position of the AR information regarding the shop B, determines the ceiling space 50D near the shop C as the display position of the AR information regarding the shop C, and determines the ceiling space 50F near the shop D as the display position of the AR information regarding the shop D. Namely, in this case, the server device 2 associates each space ID corresponding to the ceiling spaces 50A, 50C, 50D and 50F with the AR information regarding each of the shops A to D and stores them on the AR information table 241. It is noted that the ceiling spaces 50B and 50E are determined to be the display position of the AR information indicating other information irrelevant to the peripheral shops A to D, for example.

It is noted that the HMD 1 may determine whether or not to display the AR information in accordance with the degree of congestion with people existing in the target space. For example, the HMD 1 recognizes the degree of the congestion of the floor based on an image captured by the camera 15. Then, at the time of determining that it is not crowded with people, the HMD 1 displays the AR information over the floor surface space 53 and the forward space 54. In contrast, at the time of determining that it is crowded with people based on the recognition of the degree of the congestion of the floor through an image captured by the camera 15, the HMD 1 displays the AR information over the ceiling space 50 instead of the floor surface space 53 and the forward space 54. It is noted that at the time of determining, based on the recognition of the degree of the congestion of the floor through an image captured by the camera 15, that it is not crowded with people, the HMD 1 displays the AR information on all of the floor surface space 53, the forward space 54 and the ceiling space 50.

[Process Flow]

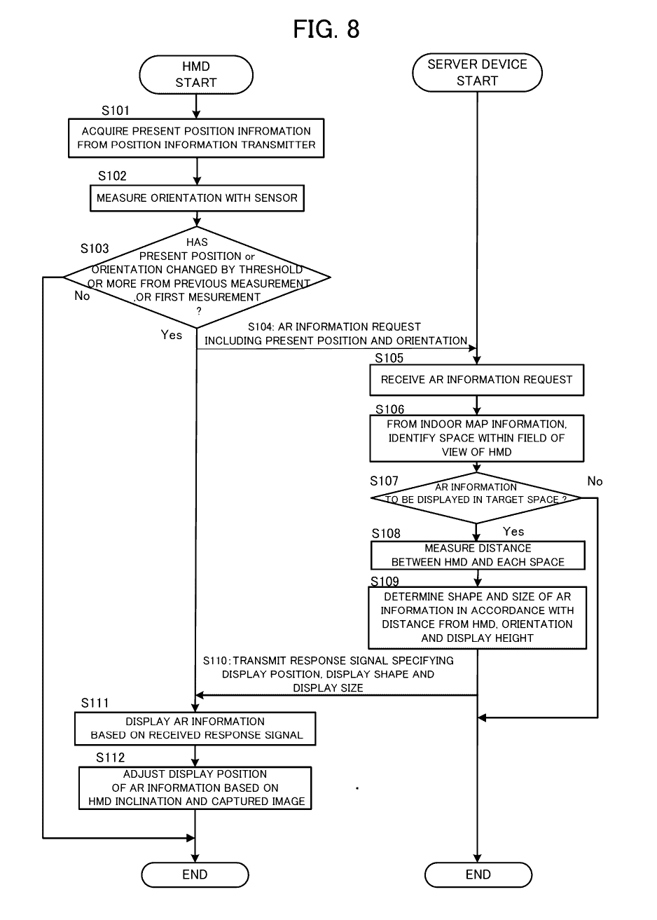

FIG. 8 is an example of a flowchart indicating the display process of the AR information according to the embodiment. The HMD 1 and the server device 2 repeatedly execute the process indicated by FIG. 8.

First, the HMD 1 acquires the present position information from the position information transmitter 3 existing in the vicinity of the HMD 1 (step S101). Concretely, the HMD 1 receives the present position information including the latitude and longitude information and the floor number information from the position information transmitter 3 through the GPS receiver 61. Next, the HMD 1 measures the orientation of the HMD 1 by the geomagnetic sensor 62 (step S102).

Then, the HMD 1 determines whether or not the present position measured at step S101 or the orientation measured at step S102 has changed by a value equal to or larger than a threshold from the previous measurement and whether or not it is a first measurement (step S103). The above-mentioned threshold is a threshold for determining whether or not the HMD 1 needs to change the AR information to be displayed and/or the display position of the AR information. For example, the threshold is determined through experimental trials. When the present position or the orientation has changed by a value equal to or larger than the threshold from the previous measurement or when it is a first measurement (step S103; Yes), the HMD 1 sends the server device 2 the request signal S1 including information on the measured present position and the measured orientation (step S104). When the present position or the orientation has not changed by the value equal to or larger than the threshold from the previous measurement (step S103; No), the HMD 1 ends the process of the flowchart.

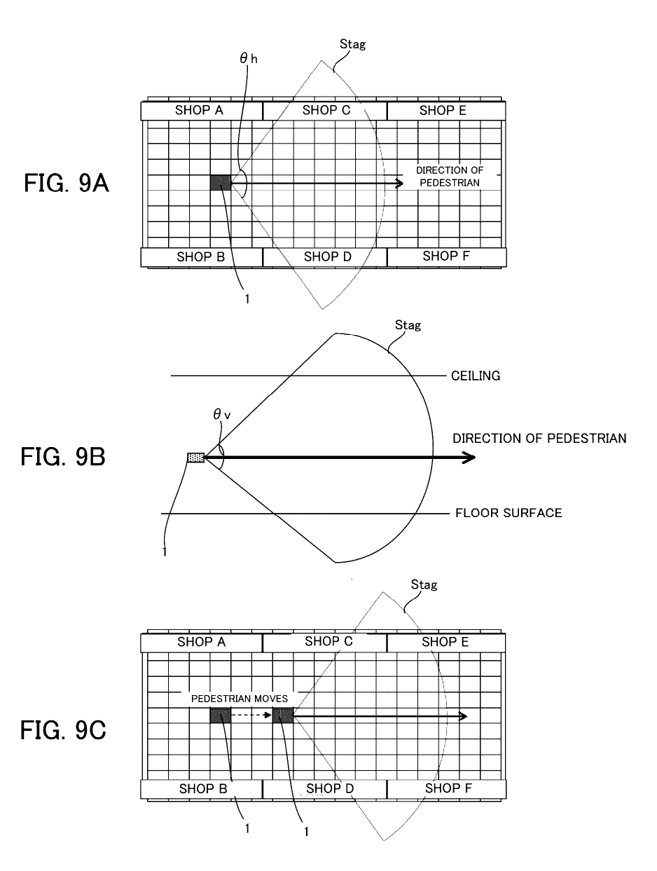

After the HMD 1 sends the request signal S1, the server device 2 receives the request signal S1 (step S105). Then, by referring to the indoor map information 240 based on the present position and the orientation indicated by the request signal S1, the server device 2 specifies a space (referred to as “display target space Stag”) existing within the display range (i.e., the field of view of the user wearing the HMD 1) of the HMD 1 (step S106). Thereby, the server device 2 identifies each space ID of the divided spaces existing in the display target space Stag. The determination method of the display target space Stag will be explained later with reference FIGS. 9A to 9C.

The server device 2 determines whether or not there is any AR information to be displayed in the display target space Stag (step S107). Namely, with reference to the AR information table 241, the server device 2 determines whether or not there is any AR information associated with the space ID of the divided spaces existing in the display target space Stag. Then, when there is AR information to be displayed in the display target space Stag (step S107; Yes), the server device 2 measures, on the basis of the present position information indicated by the request signal S1 and the indoor map information 240, the distance between the HMD 1 and each of the divided spaces where the AR information is to be displayed (step S108). For example, the server device 2 recognizes the space ID corresponding to the position indicated by the present position information and calculates the distance in the X-Y-Z coordinate system between the recognized space ID and each space ID of the divided spaces where the AR information is to be displayed. Thereafter, the server device 2 converts the calculated distance to the real distance.

Then, on the basis of the distance from the HMD 1 measured at step S108, the orientation of the HMD 1 and the height of the space where the AR information is to be displayed, the server device 2 determines the shape and the display size of each AR information to be displayed. Then, the server device 2 transmits to the HMD 1 the response signal S2 including all AR information to be displayed and information on the display position, display shape and display size with respect to each AR information (step S110). In this case, for example, as the display position information of the AR information, the server device 2 transmits three dimensional position information indicating the longitude, the latitude and the height with respect to each space where each AR information is to be displayed. In this case, as the display position information of the AR information, the server device 2 may transmits to the HMD 1 information indicating whether to display over the floor surface or to display over the ceiling. As the AR information which the HMD 1 displays or plays, the server device 2 may transmit the URL or the like registered in the AR information table 241 as it is, or may send an image or a moving image which the server device 2 acquires from the URL or the like registered in the AR information table 241.

When there is not any AR information to be displayed in the display target space Stag (step S107; No), the server device 2 ends the process of the flowchart. In this case, the server device 2 may sends the HMD 1 a response signal indicating that there is not any AR information to be displayed.

After the server device 2 transmits the response signal S2, the HMD 1 receives the response signal S2 and displays the AR information as a virtual image based on the response signal S2 (step S111). In this case, for example, the HMD 1 determines the display position of each AR information based on the relative positional relationship between the present position of the HMD 1 in consideration of the orientation thereof and the three dimensional display position specified by the response signal S2. Then, the HMD 1 displays the AR information according to the shape and the size specified by the response signal S2.

Thereafter, the HMD 1 adjusts the display position of the AR information in accordance with inclination with respect to the horizontal plane of the HMD 1 detected by an acceleration sensor which is not shown, and/or adjusts the display position of the AR information based on an image captured by the camera 15 (step S112). In the latter case, for example, the HMD 1 detects the position of the ceiling or the floor surface based on an image captured by the camera 15 to adjust the display position and the display shape of the AR information along with the detected position of the ceiling or the floor surface.

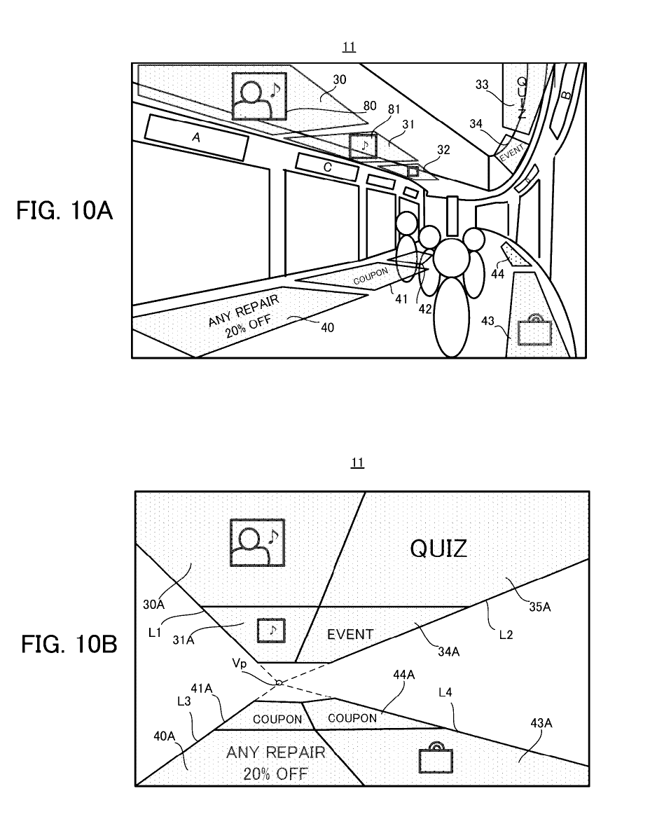

When the AR information to be displayed is a moving image (including animation) or audio data, the HMD 1 determines whether or not the line of sight of the user is directed to the display area of the AR information corresponding to the moving image or the audio data based on a common visual line recognition technique. Then, if the line of sight of the user is directed to the display area, the HMD 1 plays the corresponding moving image or the audio data. In this case, preferably, if the line of sight of the user is not directed to the display area of the above-mentioned AR information, the HMD 1 displays an icon image indicating that the AR information corresponds to the moving image or the audio data. The detail thereof will be described later with reference to FIGS. 10A and 10B each illustrating a display example.

Next, the determination method of the display target space Stag executed at step S106 will be explained with reference to FIGS. 9A to 9C.

FIG. 9A illustrates a positional relationship on the X-Y plane between the HMD 1 and the display target space Stag. FIG. 9B illustrates a positional relationship on the Y-Z plane between the HMD 1 and the display target space Stag. FIG. 9C illustrates the transition of the display target space Stag on the X-Y plane before and after the movement of the HMD 1.

As illustrated in FIGS. 9A and 9B, as the display target space Stag, the server device 2 identifies such a fan-shaped range with predetermined length that it laterally and evenly spreads at an angle “θh” from the HMD 1 and it also spreads in the height direction at an angle “θv” from the HMD 1. The angle θh is determined to be the same as the view angle of a human in the horizontal direction, for example. The angle θv is determined to be the same as the view angle of a human in the height direction, for example. In this case, the display target space Stag is determined to be laterally and vertically symmetrical with respect to the orientation (i.e., traveling direction of the pedestrian) of the HMD 1. Additionally, as illustrated in FIG. 9C, the server device 2 shifts the display target space Stag in accordance with the variation of the present position.

As described above, the server device 2 limits the display target space Stag to the range of a predetermined distance from the HMD 1. Thereby, the server device 2 prevents the display of the HMD 1 from being complicated due to the excess amount of the AR information to be displayed along with unnecessary expanding of the display target space Stag.

[Display Example]

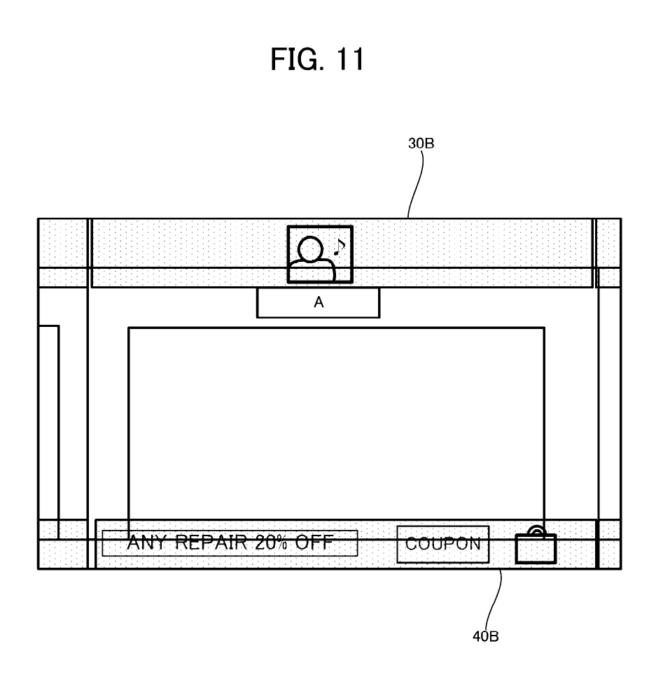

Next, display examples according to the embodiment will be explained with reference to FIGS. 10A and 10B and FIG. 11.

FIG. 10A is a display example which the user of the HMD 1 virtually recognizes through the half mirror 11 on the floor passage in the floor space Sf in such a case that the building 4 is a shopping mall. In the case of FIG. 10A, as the AR information, the HMD 1 displays images 30 to 34 and 40 to 44 over the front scenery.

In the case of FIG. 10A, the HMD 1 displays the AR information only at both edges of the ceiling space 50 and the floor surface space 53 illustrated in FIG. 7. For example, as the AR information to be displayed over the ceiling space (corresponding to the ceiling space 50A in FIG. 7) adjacent to the shop A, the HMD 1 displays the image 30 over the ceiling space by receiving the image 30 including the icon image 80 together with the audio data from the server device 2. As the AR information to be displayed over the floor surface space (corresponding to the floor surface space 53A in FIG. 7) adjacent to the shop A, the HMD 1 displays the image 40 over the floor surface space by receiving the image 40 including characters for advertisements from the server device 2. Similarly, the HMD 1 displays the image 31 including the icon image 81 over the ceiling space (corresponding to the ceiling space 50D in FIG. 7) adjacent to the shop C, and displays the image 41 indicating a coupon over the floor surface space (corresponding to the floor surface space 53D in FIG. 7). Additionally, the HMD 1 displays the image 33 indicating characters “QUIZ” over the ceiling space (corresponding to the ceiling space 50C in FIG. 7) adjacent to the shop B, and displays the image 43 indicating a recommended item of the shop B over the floor surface space (corresponding to the floor surface space 53C in FIG. 7) adjacent to the shop B. Similarly, the HMD 1 displays the image 34 indicating characters “EVENT” over the ceiling space (corresponding to the ceiling space 50F in FIG. 7) adjacent to the shop D and displays the image 44 over the floor surface space (corresponding to the floor surface space 53F in FIG. 7) adjacent to the shop D.

Then, by detecting the line of sight of the user of the HMD 1, the HMD 1 recognizes the images 30 to 34 and 40 to 44 where the line of sight is directed and executes music reproduction and the like if necessary. For example, when the HMD 1 determines that the line of sight of the user is directed to the image 30, the HMD 1 plays the audio data corresponding to the image 30. When the HMD 1 determines that the line of sight of the user is directed to the image 41, the HMD 1 displays the detail of the discount (coupon) information. When the HMD 1 determines that the line of sight of the user is directed to the image 33, the HMD 1 displays the detail of the quiz corresponding to the image 33. Similarly, at the time of determining that the line of sight of the user is directed to the image 34, the HMD 1 displays the detail of the event corresponding to the image 34. In this case, for example, as the response signal S2, the HMD 1 preliminarily receives an image, audio data or its URL to be used at the time when the line of sight is directed in addition to an image to be displayed at the time when the line of sight is not directed.

FIG. 10B illustrates an example that the AR information is displayed over substantially the whole ceiling space and floor surface space in the case of FIG. 10A. For the sake of explanation, the front scenery is not illustrated in FIG. 10B.

In this case, while displaying the images 30A, 31A, 34A and 35A in order without any spaces over the ceiling position of the floor passage, the HMD 1 displays the images 40A, 41A, 43A and 44A in order without any spaces over the floor surface position of the floor passage. Additionally, in the case of FIG. 10B, after recognizing the vanishing point Vp through a common image recognition technique, the HMD 1 displays the images 30A, 31A, 34A and 35A within the area between the lines L1 and L2 and displays the images 40A, 41A, 43A and 44A within the areas between the lines L3 and L4, wherein the lines L1 and L2 extend from the vanishing point Vp along the both edges of the ceiling and the lines L3 and L4 extend from the vanishing point Vp along the both edges of the floor surface.

FIG. 11 is a display example through the half mirror 11 in a case where the shop A is observed from the front. In the case of this example, the HMD 1 displays the image 30B similar to the image 30 illustrated in FIG. 10A over the ceiling space adjacent to the shop A. In contrast, in comparison to the image 40 illustrated in FIG. 10A, the HMD 1 increases the quantity of information indicated by the image 40B displayed over the floor surface space adjacent to the shop A. Specifically, when the shop A is observed from the front, the HMD 1 further displays the coupon information and the recommended item information by the image 40B.

In this way, when the display range of each AR information is equal to or larger than a predetermined size due to the frontal vision of the shop, i.e., when the number of the divided spaces included in the display target space Stag is equal to or smaller than a predetermined number, the HMD 1 increases the quantity of the AR information to be displayed. In this case, for example, together with the AR information to be normally displayed, the HMD 1 preliminarily receives as the response signal S2 the AR information to be displayed only when the display range of the AR information is equal to or larger than the predetermined size.

### Modification

Hereinafter, preferable modifications of the embodiment will be described. Each modification can be applied to the embodiment in combination.

### First Modification

Instead of the configuration example illustrated in FIG. 1, the HMD 1 may display the AR information without communicating with the server device 2. In this case, for example, the HMD 1 stores the indoor map information 240 and the AR information table 241 and performs each process at step S105 to step S109 illustrated in FIG. 8 in substitution for the server device 2 to determine the AR information to be displayed and the display size thereof.

Even in this mode, as with the embodiment, the HMD 1 can display the AR information. In the case of this modification, the HMD 1 is an example of “the display control device” and the half mirror 11 is an example of “the display unit” according to the present invention. It is also noted that the control unit 17 is an example of “the guide information acquisition unit”, “the display control unit”, “the position information acquisition unit” and the computer which works based on the program according to the present invention.

### Second Modification

At step S102 of the flowchart illustrated in FIG. 8, in addition to the orientation indicating the direction of the HMD 1, the HMD 1 may further detect the inclination with respect to the horizontal plane of the HMD 1 and add information on the inclination to the request signal S1 to send it to the server device 2 at step S104. In this case, the server device 2 determines the display target space Stag in further consideration of the inclination of the HMD 1.

### Third Modification

The position information transmitter 3 may send the space ID to the HMD 1 as the present position information. In this case, the HMD 1 adds the received space ID to the request signal S1 and sends the request signal S1 to the server device 2. Then, the server device 2 recognizes the position of the HMD 1 based on the received space ID.

### Fourth Modification

Instead of the HMD 1, the display system may include a portable terminal such as a smart phone equipped with a camera. In this case, while displaying on its display an image captured by the camera, the portable terminal executes the substantially the same process as the process executed by the HMD 1 according to the embodiment. Thereby, the portable terminal sends the request signal S1 and receives the response signal S2, and superimposes the AR information on the displayed image based on the received response signal S2. The portable terminal or the display thereof in this modification is an example of “the display unit” according to the present invention. When the portable terminal also has the functions of the server device 2 according to the first modification, the portable terminal is an example of the “display control device” according to the present invention.

### Fifth Modification

In such a case that the HMD 1 also stores the indoor map information 240 which the server device 2 stores, the server device 2 may specify the space ID as the display position of the AR information in the response signal S2. In this case, with reference to the indoor map information 240, the HMD 1 recognizes the latitude, the longitude and the height indicated by the space ID specified in the response signal S2, and displays the AR information at the recognized position.

### Sixth Modification

In the explanation regarding FIG. 7, the HMD 1 performs the control of switching the space (e.g., the ceiling space 50 or the floor surface space 53) where the AR information is to be displayed in accordance with the degree of the congestion with people in the floor space Sf. Instead, the server device 2 may perform the control of switching the space where the AR information is to be displayed.

For example, the server device 2 recognizes the information on the degree of congestion in the floor space Sf by processing an image outputted from a monitoring camera provided in the floor space Sf, or by accepting an input regarding the degree of congestion from the administrator. Then, when the server device 2 determines that the floor space Sf is not congested, the server device 2 acquires the AR information corresponding to the floor surface space 53 and the forward space 54 from the AR information table 241 to let the HMD 1 display the acquired AR information. In contrast, when the server device 2 determines that the floor space Sf is congested, the server device 2 acquires the AR information corresponding to the ceiling space 50 from the AR information table 241 to let the HMD 1 display the acquired AR information.

### Seventh Modification

The HMD 1 may fix the direction of characters illustrated by the displayed AR information to the floor space Sf regardless of the orientation of the HMD 1 as with signboards of shops, posters or paint on walls. In this case, when the user of the HMD 1 takes a 180-degree turn and looks toward the direction where the user walked, the AR information is displayed in a horizontally reversed state. According to this mode, the HMD 1 can let the user visually recognize the AR information seen through the half mirror 11 as a fixed object existing in the floor space Sf as with signboards of shops and posters.

In another example, the HMD 1 may adjust the direction of characters indicated by the displayed AR information so that the user can see them from the front at all times. In this case, the HMD 1 displays the characters indicated by the AR information always in a constant direction with respect to the half mirror 11. In this case, even when the user of the HMD 1 takes a 180-degree turn and look toward the direction where the user walked, the AR information is not horizontally nor vertically reversed.

### Eighth Modification

The HMD 1 may detect the traveling speed of the user by an acceleration sensor included in the measurement unit 16 thereby to switch the display/non-display of the AR information in accordance with the detected traveling speed. In this case, when the detected traveling speed is equal to or higher than a threshold, the HMD 1 does not display the AR information. For example, the above-mentioned threshold is determined through experimental trials in consideration of the degree of the deterioration of the visibility. Thereby, it is preferably possible to suppress the display of the AR information at the time of high-speed movement of the user from being complicated due to frequent switching of the AR information displayed by the HMD 1.

Similarly, the HMD 1 may adjust the quantity of the AR information in accordance with the detected traveling speed. For example, the lower the detected traveling speed is, the more the HMD 1 increases the quantity of the AR information to be displayed by additionally displaying information on a coupon or an item as with the image 40B in FIG. 11, and the HMD 1 decreases the quantity of the AR information to be displayed with increasing detected traveling speed. Thereby, in accordance with the traveling speed of the user, the HMD 1 can display the AR information which the user can visually recognize and whose quantity is adequate.

### Ninth Modification

The server device 2 may switch the AR information to be displayed by the HMD 1 in accordance with the timing of the display by the HMD 1 and the access frequency to the server device 2.

As an example of the former case, a description will be given of an example of switching the AR information in accordance with the time zone of the display. In this case, the server device 2 stores the AR information table 241 which specifies the AR information per time zone, and at the time of receiving the request signal S1, determines the AR information to be specified in the response signal S2 with reference to the AR information table 241 corresponding to the time zone including the present time.

When switching the AR information to be displayed in accordance with the access frequency to the server device 2, the server device 2 associates the terminal ID of the HMD 1 which is the transmitter of the request signal S1 with the number (simply referred to as “access number”) of the transmission of the request signal S1 per transmission place (e.g., per floor space Sf) and preliminarily stores them. The server device 2 stores the AR information table 241 in which the AR information to be displayed is specified with respect to each access number. When the server device 2 receives the request signal S1, the server device 2 recognizes the access number of the HMD1 that is the transmitter of the request signal S1. Then, on the basis of the recognized access number, the server device 2 extracts the AR information to be displayed from the AR information table 241 to send the response signal S2 including the information on the AR information to be displayed. According to this example, the HMD 1 can change the content of the AR information in accordance with the frequency to display the AR information. Namely, in such a case that the user passes through a place where the user has previously passed, the HMD 1 can properly switch the content of the AR information to be displayed over the ceiling of the place or the floor surface thereof in accordance with the times the user passed through the place.

### Tenth Modification

The server device 2 may recognize the user's preference regarding the category of shops which the user tends to visit by recognizing the moving position of the user of the HMD 1 based on the present position information included in the request signal S1.

In this case, every time the server device 2 receives the request signal S1, the server device 2 recognizes the category of the shop corresponding to the space ID indicating the position of the HMD 1 by referring to items “SPACE ID” and “CATEGORY” in the shop information table 242 illustrated in FIG. 6. Thereby, the server device 2 counts the frequency per category of shops, and associates and stores the result thereof with the terminal ID of the HMD 1. Then, on the basis of the counted frequency, the server device 2 recognizes the category of stores which the user of the HMD 1 prefers.

In this case, preferably, the server device 2 may let the HMD 1 display the AR information for navigating to the places of a shop falling under the recognized favorite category of the user of the HMD 1. For example, in the case of FIG. 10, the server device 2 may let the HMD 1 display the AR information indicating information on a shop in the favorite category of the user of the HMD 1 and its location over the unoccupied space corresponding to the center part of the ceiling space. In another example, when the server device 2 lets the HMD 1 display the AR information corresponding to a shop in the recognized favorite category of the user of the HMD 1, the server device 2 may specify the display mode of the AR information through the response signal S2 so that the display size of the AR information is magnified. In this case, the server device 2 may specify the display mode of the AR information through the response signal S2 so that the AR information corresponding to the shop in the favorite category differs from other AR information in the display color, the display luminance and/or the display shape in addition to the display size thereof. Thereby, the server device 2 can let the HMD 1 emphatically display the AR information corresponding to the shop in the favorite category of the user of the HMD 1.

### Eleventh Modification

Even at the time of the HMD 1 moving outdoors, the display system may let the HMD 1 display the AR information as with the above-mentioned embodiment in which the HMD 1 moves in the interior of the building 4.

In this case, for example, the HMD 1 recognizes the present position based on the electric wave sent from GPS satellites. The server device 2 stores the AR information table 241 in which the AR information is associated with the space ID corresponding to the road surface or the airspace with respect to each road. At the time of receiving the request signal S1, the server device 2 determines the AR information to be displayed over a road surface or airspace with reference to the AR information table 241 in the same way as the embodiment and sends the response signal S2 to the HMD 1. It is also noted that the display system may display the AR information indicating the facility information over a side path or footway at the time when the user of the HMD 1 travels by vehicle.

### Twelfth Modification

At step S109, the server device 2 may determine the display color and the display luminance of the AR information in addition to the shape and the size of the AR information to send the response signal S2 including the determined information. In this case, for example, with reference to a predetermined map, the server device 2 determines the display color and the display luminance based on the display height of the AR information and the distance from the HMD 1 to the divided space for displaying the AR information.

### Thirteenth Modification

The server device 2 may let the HMD 1 display the AR information over the forward space 54 instead of or in addition to the ceiling space 50 and/or the floor surface space 53 illustrated in FIG. 7 so that the AR information appears to float in the air.

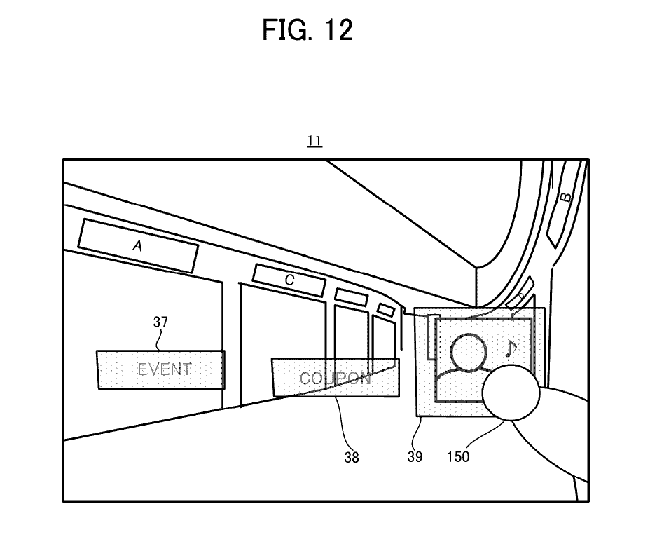

FIG. 12 is an display example which the user of the HMD 1 visually recognizes through the half mirror 11 on the floor passage in the floor space Sf according to this modification. In the case of FIG. 12, the HMD 1 receives from the server device 2 images 37 to 39 as the AR information for displaying over the front space (corresponding to the forward space 54 in FIG. 7) other than the ceiling and the floor surface in order to display the images 37 to 39 over the front space.

Then, the HMD 1 recognizes the position of a hand of the user based on an image captured by the camera 15. Then, in case of determining that the hand of the user touches any one of the images 37 to 39 (e.g., overlaps the display position of any one of the images 37 to 39), the HMD 1 assumes that the touched image is selected. For example, in the case of FIG. 12, the HMD 1 recognizes the hand 150 of the user through the camera 15 and determines that the recognized hand 150 overlaps the display position of the image 39. Thus, in this case, the HMD 1 plays the audio data corresponding to the image 39. Similarly, in case of determining that the image 37 is touched by the hand 150, the HMD 1 displays the detail information on the event indicated by the image 37. The HMD 1 also displays the detail information on the coupon indicated by the image 38 in case of determining that the image 38 is touched by the hand 150.

Preferably, in this case, by using information on the body length of the user of the HMD 1 preliminary stored as user information, the HMD 1 displays the images 37 to 39 as virtual images at such a position that a hand of the user can reach without disturbing the visibility of the user.

### BRIEF DESCRIPTION OF REFERENCE NUMBERS

1 HMD
2 Server device
3 Position information transmitter
4 Building

1. A display control device comprising:
a guide information acquisition unit configured to acquire guide information on a guide to a target space and three dimensional coordinate information on a display position of the guide information in the target space; and
a display control unit configured to let a display unit display the guide information to visually overlap the target space based on the guide information and the three dimensional coordinate information which are acquired by the guide information acquisition unit, the display control unit changing a content of the guide information which the display unit displays in accordance with the present time.

2. The display control device according to claim 1, further comprising
a position information acquisition unit configured to acquire information on a position of the display unit in the target space and an orientation in which the display unit is directed,
wherein the display control unit is configured to determine, on a basis of the position and the orientation acquired by the position information acquisition unit, a display mode of the guide information acquired by the guide information acquisition unit and to let the display unit display the guide information.

3. The display control device according to claim 1,
wherein the target space is a space including a ceiling and a passage,
wherein the three dimensional coordinate information is coordinate information on the ceiling and the passage, and
wherein the display control unit is configured to let the display unit display the guide information to visually overlap the ceiling or the passage based on the three dimensional coordinate information.

4. The display control device according to claim 1,
wherein the display control unit is configured to switch the display position of the guide information or change a quantity of the guide information based on a traveling speed of the display unit.

5. (canceled)

6. The display control device according to claim 1,
wherein the display control unit is configured to recognize, on a basis of position information on the display unit, a category of shops which an observer of the display unit frequently visits and let the display unit display information for navigating the observer to a shop falling under the category as the guide information.

7. The display control device according to claim 1,
wherein the guide information includes audio data, and
wherein the display control unit is configured to let an audio output unit output the audio data.

8. The display control device according to claim 1, further comprising:
a storage unit configured to associate and store guide information to be displayed with each of divided spaces into which the target space is divided; and
a position information acquisition unit configured to acquire, from the display unit, information on a position of the display unit in the target space and an orientation where the display unit is directed,
wherein the guide information acquisition unit is configured to recognize, on a basis of the position and the orientation, at least one of the divided spaces included in the display range of the display unit thereby to acquire the guide information associated with the at least one of the divided spaces and the three dimensional coordinate information thereof.

10. A display control device comprising:
a guide acquisition unit configured to acquire first shop guide information that is guide information on a first shop and second shop guide information that is guide information on a second shop; and
a display control unit configured to let a display unit display the first shop guide information acquired by the guide acquisition unit to visually overlap a front of the first shop and display the second shop guide information acquired by the guide acquisition unit to visually overlap a front of the second shop.

11-13. (canceled)

14. A display control device comprising:
a guide information acquisition unit configured to acquire guide information on a guide to a target space and three dimensional coordinate information on a display position of the guide information in the target space; and
a display control unit configured to let a display unit display the guide information to visually overlap the target space based on the guide information and the three dimensional coordinate information which are acquired by the guide information acquisition unit, the display control unit changing a content to be displayed as the guide information based on a frequency of displaying the guide information through the display unit.

15. The display control device according to claim 14, further comprising
a position information acquisition unit configured to acquire information on a position of the display unit in the target space and an orientation in which the display unit is directed,
wherein the display control unit is configured to determine, on a basis of the position and the orientation acquired by the position information acquisition unit, a display mode of the guide information acquired by the guide information acquisition unit and to let the display unit display the guide information.

16. The display control device according to claim 14,
wherein the target space is a space including a ceiling and a passage,
wherein the three dimensional coordinate information is coordinate information on the ceiling and the passage, and
wherein the display control unit is configured to let the display unit display the guide information to visually overlap the ceiling or the passage based on the three dimensional coordinate information.

17. The display control device according to claim 14,
wherein the display control unit is configured to switch the display position of the guide information or change a quantity of the guide information based on a traveling speed of the display unit.

18. The display control device according to claim 14,
wherein the display control unit is configured to recognize, on a basis of position information on the display unit, a category of shops which an observer of the display unit frequently visits and let the display unit display information for navigating the observer to a shop falling under the category as the guide information.

19. The display control device according to claim 14,
wherein the guide information includes audio data, and
wherein the display control unit is configured to let an audio output unit output the audio data.

20. The display control device according to claim 14, further comprising:
a storage unit configured to associate and store guide information to be displayed with each of divided spaces into which the target space is divided; and
a position information acquisition unit configured to acquire, from the display unit, information on a position of the display unit in the target space and an orientation where the display unit is directed,
wherein the guide information acquisition unit is configured to recognize, on a basis of the position and the orientation, at least one of the divided spaces included in the display range of the display unit thereby to acquire the guide information associated with the at least one of the divided spaces and the three dimensional coordinate information thereof.

21. The display control device according to claim 10,
wherein the display control unit is configured to let the display unit display the first shop guide information and the second shop guide information in a state that the first shop guide information does not overlap the second shop guide information.
